(19) United States
(12) Patent Application Publication
(10) Pub. No.: US 2020/0114387 A1
(43) Pub. Date: Apr. 16, 2020

(54) DISPENSE PATTERNS THAT DISPERSE FLUIDS

(71) Applicant: HEWLETT-PACKARD DEVELOPMENT COMPANY, L.P., Spring, TX (US)

(72) Inventor: David H. OCHS, Corvallis, OR (US)

(21) Appl. No.: 16/603,842

(22) PCT Filed: Sep. 27, 2017
(86) PCT No.: PCT/US2017/053726

§ 371 Date: Oct. 9, 2019

(51) Int. Cl. B05C 11/10; B05C 5/02

(52) U.S. Cl. CPC B05C 11/10; B01L 3/0268; B05C 5/0225

(57) ABSTRACT

In example implementations, a method is provided. The method may be executed by a processor of a fluid dispensing apparatus. The method includes determining to add a fluid at a location. A dispense pattern to dispense the fluid at the location is determined. The fluid is dispensed in accordance with the dispense pattern that disperses the fluid into different spots within the location.

### BACKGROUND

Laboratories often run experiments using various different liquids to obtain different types of experimental data. The experiments may use fluid dispensers that dispense fluid into wells of a microplate or an experimental surface to perform the various different experiments.

In some experiments, the fluids may be dispensed into different locations (e.g., wells in a micro plate or locations on a slide or plate that is used to grow bio-matter). A dispensing protocol may be used by the fluid dispensing apparatus that controls which fluids are dispensed in which locations. In addition, the dispensing protocol may control a dispensing pattern of the fluids in each target location of the surface or surfaces.

### BRIEF DESCRIPTION OF THE DRAWINGS

FIG. 1 is a block diagram of an example apparatus of the present disclosure;

FIG. 2 is another block diagram of an example apparatus of the present disclosure;

FIG. 3 is a block diagram of different spots within a location of the present disclosure;

FIG. 4 is a flow chart of an example method for dispersing a fluid during a fluid dispense; and

FIG. 5 is a block diagram of an example non-transitory computer readable storage medium storing instructions executed by a processor.

### DETAILED DESCRIPTION

Examples described herein provide an apparatus and a method for dispersing a fluid during a fluid dispense. As discussed above, the fluids may be dispensed into different locations (e.g., wells in a micro plate or locations on a slide or plate that is used to grow bio-matter). A dispensing protocol may be used by the fluid dispensing apparatus that controls which fluids are dispensed in which locations. In addition, the dispensing protocol may control a dispensing pattern of the fluids in each target location of the surface or surfaces.

In some instances, it may be advantageous to disperse the fluid that is being dispensed. For example, dispensing an entire volume of a fluid on the same spot at location may have negative effects. For example, the fluid may be toxic to a mass being grown, and to prevent killing the mass, the fluid may be dispersed over different spots within the location.

The fluid dispersion may also be used to normalize a volume of a fluid. For example, sometimes the total volume of a fluid may not be consistent across experimental regions during the patterned dispense. This may cause issues or inaccuracies in the experimental data. As a result, additional fluid may be added to different locations of a pattern across different layers at a common location.

Examples described herein provide a fluid dispensing apparatus that allows a user to disperse a fluid dispense across different spots within a location and to normalize a volume of a fluid across different patterns on different layers at a same location. In other words, instead of adding all of the fluid in a center area of the target location, the additional fluid may be spread out over different spots within the target location.

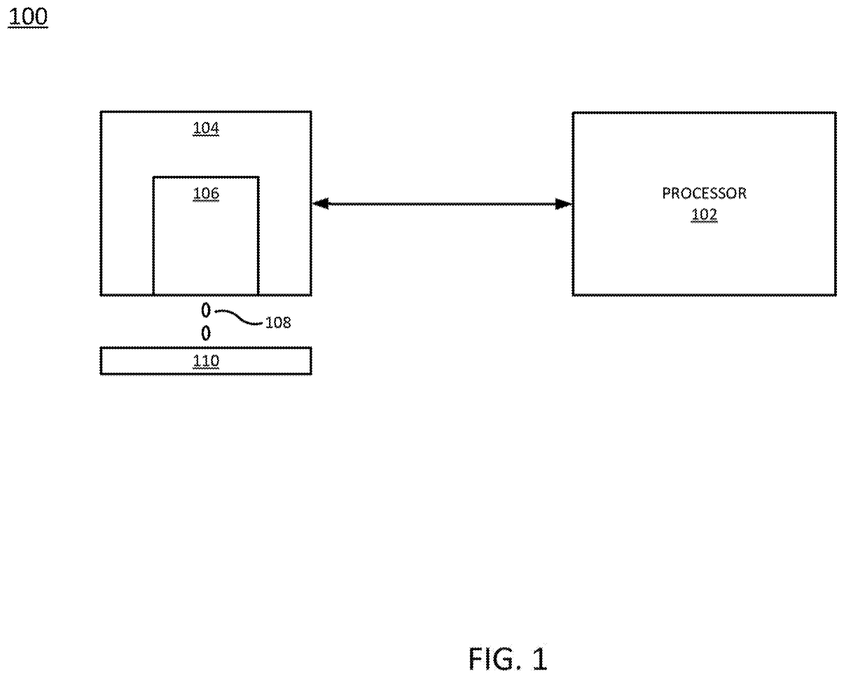

FIG. 1 illustrates a block diagram of a fluid dispensing apparatus 100. In one example, the fluid dispensing apparatus 100 may include a processor 102 and a dispenser 104. The processor 102 may be communicatively coupled to the dispenser 104. The processor 102 may control operations of the dispenser 104.

In one example, the dispenser 104 may be a cassette that includes a dispense head 106. Although a single dispense head 106 is illustrated in FIG. 1, it should be noted that the dispenser 104 may include any number of dispense heads 106. The dispense head 106 may dispense a fluid 108 onto various locations of a surface 110. The fluid 108 may be any type of fluid used for a particular dispense protocol. For example, the fluid 108 may be chemical liquids such as aqueous based compounds with optional surfactant or glycerol that is added, dimethyl sulfoxide (DMSO) based compounds, and the like.

Although the examples disclosed below use a dispense head 106, it should be noted that the dispenser 104 may be a digital pipette system, or any other type of dispenser. Thus, the examples described below that use a dispense head may be equally applicable to other types of dispensers.

The surface 110 may be a microplate with a plurality of wells, an experimental surface for growing a mass, a mounted paper, a surface with electronic sensors, and the like. The processor 102 may control the dispenser 104 and dispense head 106 to dispense the fluid 108 onto various locations of the surface 110.

It should be noted that FIG. 1 has been simplified for ease of explanation. For example, the fluid dispensing apparatus 100 may include additional components that are not illustrated. For example, the dispenser 104 may include a movable platform, the dispense head 106 may include a reservoir and a nozzle, and fluid dispensing apparatus 100 may include a platform to support the surface 110, a housing, a memory to store instructions (e.g., a dispensing protocol) executed by the processor 102, and the like.

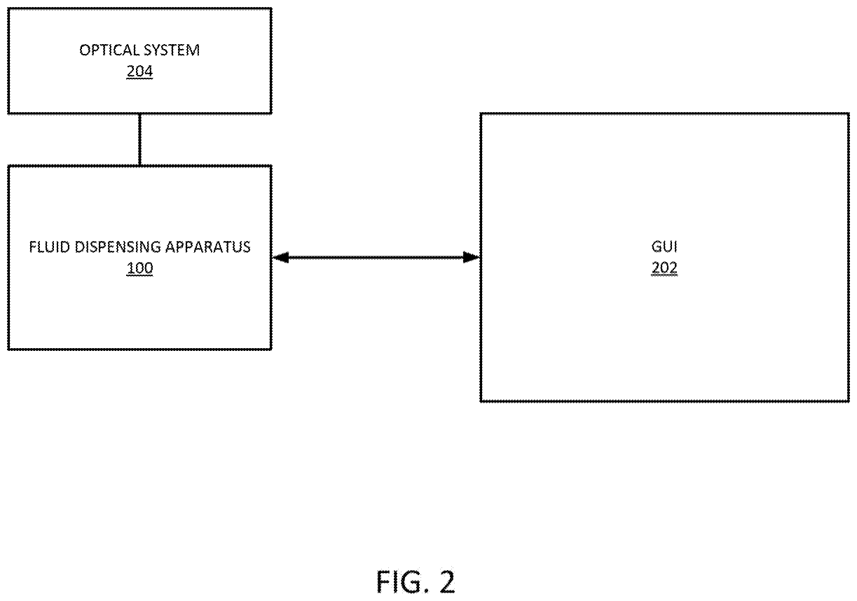

FIG. 2 illustrates another block diagram of the fluid dispensing apparatus 100 that is communicatively coupled to a graphical user interface (GUI) 202 and an optical system 204. In one example, the optical system 204 may include a camera (e.g., a fiber optic camera, a red, green, blue (RGB) camera, a microscopic camera, and the like) that may capture images of surface 110. For example, the optical system 204 may be used to capture images of locations on the surface 110. The processor 102 may analyze the images and determine a dispensing pattern of the fluid 108 that disperses the fluid 108 into different spots at a location. The dispensing pattern may include a number of drops to dispense of the fluid 108, a volume of each drop of the fluid 108, a shape of the additional fluid 108 that will be dispensed at a location, and the like.

In one example, the GUI 202 may receive inputs and provide outputs. In one example, the GUI 202 may be a touchscreen interface, and a user may provide inputs via touch selections. In another example, the GUI 202 may receive inputs via external input/output devices such as a mouse, touch pad, and the like.

In one example, the GUI 202 may provide an option to start the dispense pattern or the volume normalization process, as discussed in further details below. For example, the option may be provided as a button or through a series of selectable menus.

The GUI 202 may ask for an input or inputs before the fluid dispense pattern or the volume normalization process begins. With respect to the fluid dispense pattern, the GUI 202 may allow the user to select or define the dispense pattern or have the fluid dispensing apparatus 100 automatically determine the dispense pattern using the optical system 204. If the user wants to select or define the dispense pattern, the GUI 202 may prompt the user for information such as, which fluids 108 should be dispersed, a dispense pattern for each fluid 108 if more than one fluid 108 is dispensed, a number of different spots at which to dispense the fluid 108, a geometric shape or user defined pattern in which to dispense the number of different spots, and the like.

In one example, if the user also selects to perform a volume normalization process, the GUI 202 may prompt the user for input such as a location to normalize the volume to (e.g., a particular well in a microplate, a particular pattern on an experimental surface, a particular set of locations on a surface, and the like), a user selected volume to normalize the volume to, which fluids 108 may be related or grouped together for the normalization process, and the like. For example, the normalization process may normalize different fluids 108 that may be grouped together or defined to be related by the user.

The GUI 202 may provide outputs as the dispense head 106 is dispensing the fluid 108 at the desired spots within the desired location on the surface 110. The outputs may include information such as a current progress of the fluid dispersion, which fluid 108 is currently being dispersed, a current dispensing location on the surface 110 during a volume normalization process if selected, when the dispense pattern or the volume normalization process is completed, and the like.

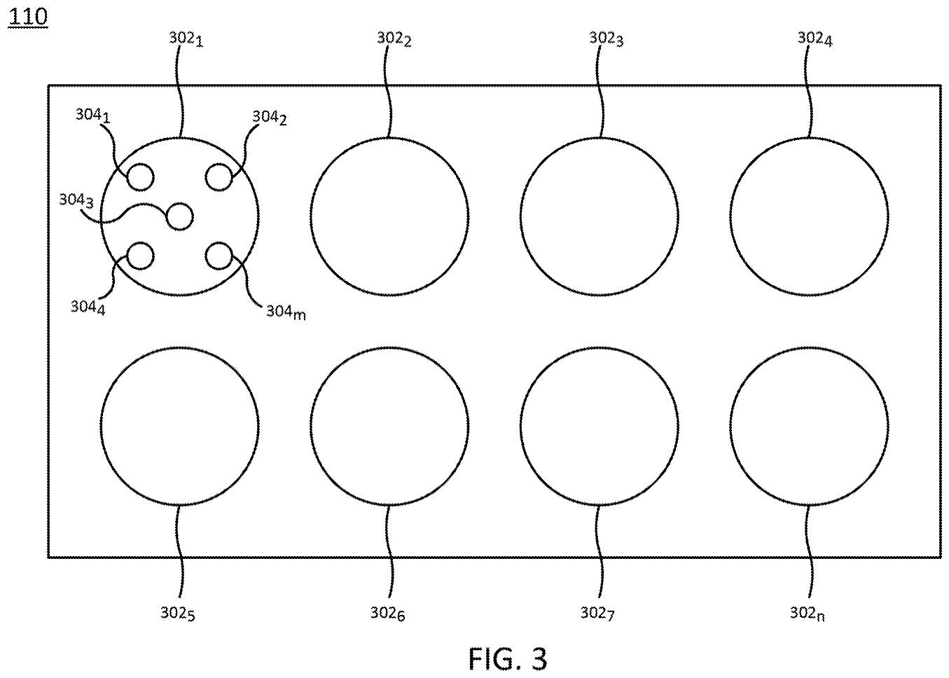

FIG. 3 illustrates a block diagram of different spots within a location. For example, a surface 110 may have different locations 302₁ to 302ₙ (also herein referred to individually as a location 302 or collectively as locations 302). When the fluid 108 is added into a particular location 302 (e.g., the location 302₁), the fluid 108 may be dispersed into different spots 304₁ to 304ₘ (herein also referred to individually as a spot 304 or collectively as spots 304). Although eight locations 302 and five spots 304 are illustrated in FIG. 3, it should be noted that any number of locations may be deployed on the surface 110 and that any number of spots may be used within the location.

In one example, the number and location of the spots 304 used to disperse the fluid 108 may be defined by a dispense pattern. As noted above, the dispense pattern may be automatically defined by the fluid dispensing apparatus 100 based on images captured by the optical system 204 or may be defined by the user. As discussed above, it may be advantages to spread the additional volume of the fluid in different areas of the dispense location to more evenly dispense the fluid.

In one example, the dispense pattern may be in a particular shape. For example, the shape may follow the shape of a pattern on a layer of an experimental surface, or a shape of a well (e.g., a circle, a rectangle, a square, a polygon, and the like). In another example, the shape may be determined or selected by a user via the GUI 202. In another example, the shape may be determined based on an analysis of images captured by the optical system 204.

In one example, the shape may be a symmetric or two-dimensional geometric shape (e.g., a square, a rectangle, a circle, an ellipse, a polygon, and the like). In another example, the shape may be an asymmetric or irregular shape. For example, the shape may be an outline of a mass that is growing on the surface 110, based on a concentration of a fluid in different spots 304 within the location 302, and the like.

In one example, the dispense pattern may define a number of drops to disperse of the fluid 108. A volume of each one of the drops may be defined as well. For example, some drops may be larger or smaller than others. In one example, the drops may each be the same size or volume.

In one example, the dispense pattern may be defined for each location 302 for a plurality of different locations 302. When the dispense pattern includes a dispersion of the fluid 108 into different spots in a plurality of different locations, the fluid 108 may be dispensed sequentially. For example, the fluid 108 may be dispersed in different spots 304₁ to 304ₘ in accordance with the dispense pattern in a location 302₁, then the fluid 108 may be dispersed in different spots 304₁ to 304ₘ in accordance with the dispense pattern in a location 302₂, and so forth.

In another example, the fluid 108 may be dispensed incrementally at different times during the dispense pattern. For example, the fluid 108 may be dispensed in spot 304₁ at location 302₁, then the fluid 108 may be dispensed in spot 304₁ at location 302₂. The dispense pattern may return to location 302₁ and dispense the fluid 108 in spot 304₂ at the location 302₁, and then dispense the fluid 108 in spot 304₂ at the location 302₂, and so forth.

As discussed above, the dispense pattern may also be used to perform a volume normalization. In one example, it may be determined that the volume of the fluid in the locations 302₁-302₄ should be normalized. In one example, the volume of the fluid may be normalized compared to one of the locations 302₁-302₄. For example, the volume of the fluid at the locations 302₁-302₃ may be normalized to the volume at a location having the highest volume of the fluid (e.g., the location 302₄). To illustrate, the location 302₄ may contain 50 microliters (μL) of the fluid, the location 302₁ may contain 25 μL of the fluid, the location 302₂ may contain 40 μL of the fluid, and the location 302₃ may contain 35 μL of the fluid. Thus, 25 μL of the fluid may be added to the location 302₁, 10 μL of the fluid may be added to the location 302₂ and 15 μL of the fluid may be added to the location 302₃.

In another example, the volume of the fluid in the locations 302₁-302₄ may be normalized to a desired value set by a user via the GUI 202. For example, the user may want to normalize the volume at each location 302₁-302₄ to 70 μL. The location 302₁ may contain 60 μL of the fluid, the location 302₂ may contain 50 μL of the fluid, and the location 302₃ may contain 60 μL of the fluid, and the location 302₄ may contain 65 μL of the fluid. Thus, 10 μL of the fluid may be added to the location 302₁, 20 μL of the fluid may be added to the location 302₂, 10 μL of the fluid may be added to the location 302₃ and 5 μL of the fluid may be added to the location 302₄. In some examples, if a location 302 has a volume of the fluid over the desired value, then no additional fluid 108 may be added.

Although the examples provided above are illustrated in different locations 302 on a surface 110, it should be noted that the examples may be applied to different patterns in different layers at the same location 302. For example, different patterns may be layered on top of one another at a single location 302. The volume of the fluids in the patterns in each layer at the same location may be normalized. For example, the location 302₁ may have a pattern on a first layer that has 10 μL of the fluid and a pattern on a second layer that has 20 μL of the fluid. The location may be normalized to a desired value of 70 μL. Thus, 40 μL of the fluid may be added to the location 302₁.

In some examples, the volume normalization may be performed multiple times as volumes of the fluid change over time. For example, the patterns in the different layers that were used to initially normalize the volume may change, causing the value that the volume is normalized against to change. As a result, a first volume normalization may be performed based on an initial volume and then a second volume normalization may be performed at a later time as the volume of the different patterns in each layer change over time.

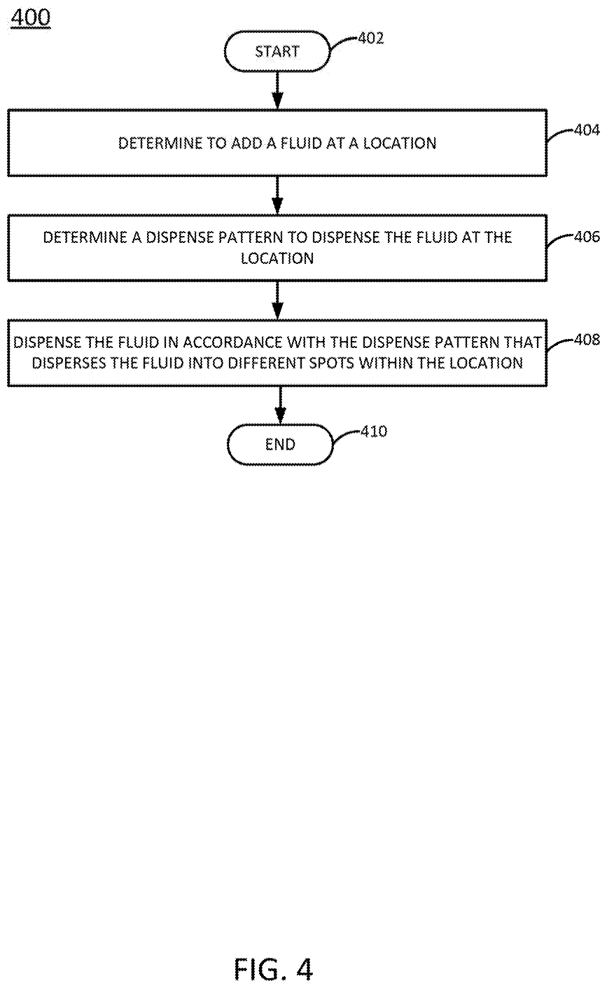

FIG. 4 illustrates a flow diagram of an example method 400 for dispersing a fluid during a fluid dispense. In one example, the method 400 may be performed by the fluid dispensing apparatus 100.

At block 402, the method 400 begins. At block 404, the method 400 determines to add a fluid at a location. For example, the fluid may be added as part of a dispense protocol that is being executed by the fluid dispensing apparatus or due to a normalization process that is being performed.

At block 406, the method 400 determines a dispense pattern in which to dispense the fluid at the location. In one example, the dispense pattern may disperse the fluid at different spots within the location. In other words, rather than dispensing the entire amount of fluid on a single spot (e.g., a center of the location), the fluid is dispersed at different spots in the location.

The dispense pattern may define a number of drops, a size of the drops (e.g., a drop diameter), a shape in which the drops will be dispensed, and the like. In one example, the dispense pattern may be automatically defined based on analysis of images captured by an optical system. In one example, the dispense pattern may be defined by a user.

At block 408, the method 400 dispenses the fluid in accordance with the dispense pattern that disperses the fluid into different spots within the location. In one example, the dispense pattern may define how the fluid may be dispersed into more than one location. For example, two different locations may have the fluid dispersed when dispensed into the two different locations.

In one example, the dispense pattern may dispense the fluid sequentially. For example, the fluid may be dispersed in different spots in the first location, and then the fluid may be dispersed in different spots in the second location.

In another example, the dispense pattern may dispense the fluid incrementally at different times. For example, a portion of the fluid may be added to a first spot of the first location, a portion of the fluid may be added to a second spot of the second location, an additional portion of the fluid may be added to a second spot of the first location, an additional portion of the fluid may be added to a second spot of the second location, and so forth, until desired amount of fluid is added to the different spots in the first location and the second location.

In one example, the dispense pattern may be different for the different locations. For example, the first location may disperse the fluid using 20 drops in a first shape and the second location may disperse the fluid using 10 drops in a second shape that is different than the first shape. In one example, multiple fluids may be added, and each fluid may be dispersed using a different dispense pattern. At block 410, the method 400 ends.

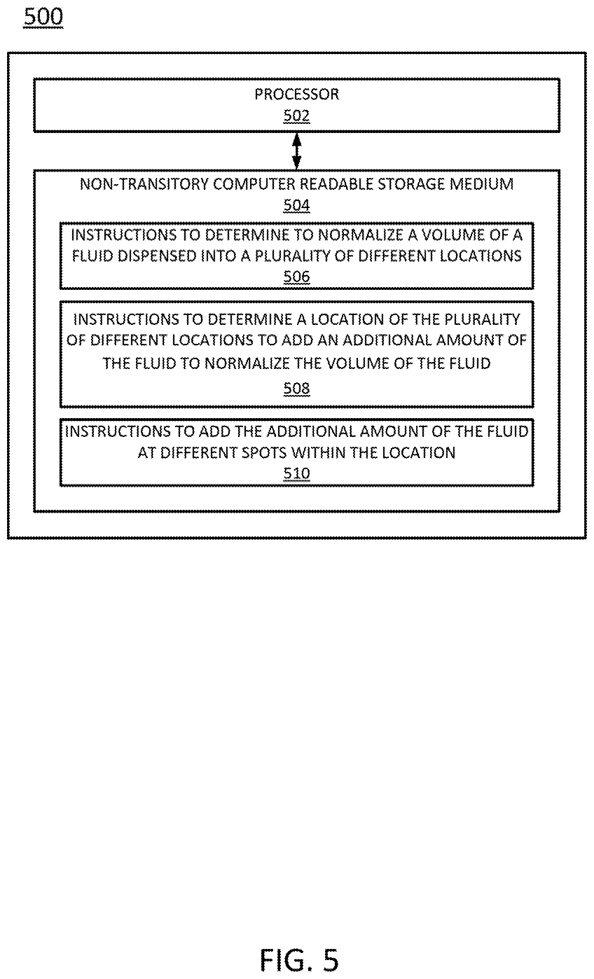

FIG. 5 illustrates an example of an apparatus 500. In one example, the apparatus 500 may be the fluid dispensing apparatus 100. In one example, the apparatus 500 may include a processor 502 and a non-transitory computer readable storage medium 504. The non-transitory computer readable storage medium 504 may include instructions 506, 508, and 510 that, when executed by the processor 502, cause the processor 502 to perform various functions.

The instructions 506 may include instructions to determine to normalize a volume of a fluid dispensed into a plurality of different locations. In some instances, the user may want to have the same volume of a particular fluid or fluids in each location. For example, experimental data may be more accurate when data is collected based on normalized volumes of the fluid.

In one example, the user may initiate a volume normalization process via a GUI of the fluid dispensing apparatus. The volume of the fluid may be tracked by the fluid dispensing apparatus during the dispense protocol. The volume of the fluid that is dispensed in each location may be used to calculate how much additional volume of the fluid should be added to each location that is to be normalized.

The instructions 508 may include instructions to determine a location of the plurality of different locations in which to add an additional amount of the fluid to normalize the volume of the fluid. In one example, the location may be at least one location that has less volume of the fluid than a reference location that has the highest volume of the fluid. In another example, the location may be determined based on at least one location that has less volume of the fluid than a desired volume set by the user via the GUI of the fluid dispensing apparatus.

In one example, the location or locations may be different patterns of different layers. The location or locations may be a subset of all the locations on the surface. For example, the different location or locations that are normalized may be grouped based on each row, user selected patterns in different layers, and the like.

The instructions 510 may include instructions to add the additional amount of the fluid at different spots within the location. For example, the different spots may be in accordance with a dispense pattern that disperses the fluid into different spots within the location. In other words, rather than dispensing the entire additional amount of the fluid on a center of the location, the additional amount of the fluid may be added in different spots on the location. For example, additional amounts of the fluid may be spread out over the location using multiple drops.

The multiple drops that are spread out over the location may each have a same volume of the fluid, or the multiple drops may have different volumes of the fluid. For example, the volume of the drops of the fluid added to the location in the first two spots may be higher than the volume of the drops of the fluid added to the location in last two spots, and so forth.

The additional amount of the fluid may be spread out in a geometric pattern that is determined by a shape of the location. For example, the geometric pattern may be the same as the shape of the location. The geometric pattern may be symmetric in that the same amount of drops are dispensed along the geometric pattern. Alternatively, the geometric pattern may be asymmetric in that additional fluid may be added unevenly around the geometric pattern. In another example the geometric pattern may be determined based on a user selected shape, or based on an analysis of images collected by an optical system, and the like.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
determining, by a processor of a fluid dispensing apparatus, to add a fluid at a location;
determining, by the processor, a dispense pattern to dispense the fluid at the location; and
dispensing, by the processor, the fluid in accordance with the dispense pattern that disperses the fluid into different spots within the location.

2. The method of claim 1, wherein the dispense pattern comprising normalizing the fluid in different patterns.

3. The method of claim 1, wherein the different patterns comprises a plurality of different patterns of a plurality of different layers within the location.

4. The method of claim 1, wherein the dispense pattern is determined based on a user selected pattern.

5. The method of claim 1, wherein the dispensing is performed sequentially for a plurality of different locations.

6. The method of claim 1, wherein the dispensing is performed incrementally at different times during the dispense pattern.

7. The method of claim 1, wherein the dispense pattern is determined based on an analysis of an image captured by an optical system.

8. A non-transitory computer readable storage medium encoded with instructions executable by a processor, the non-transitory computer-readable storage medium comprising:
instructions to determine to normalize a volume of a fluid dispensed into a plurality of different locations;
instructions to determine a location of the plurality of different locations to add an additional amount of the fluid to normalize the volume of the fluid; and
instructions to determine the additional amount of the fluid at different spots within the location.

9. The non-transitory computer readable storage medium of claim 8, wherein the different spots comprise a geometric pattern within the location.

10. The non-transitory computer readable storage medium of claim 9, wherein the geometric pattern is a same shape as a pattern of the location.

11. The non-transitory computer readable storage medium of claim 8, wherein the different spots is based on a user selected dispense pattern.

12. The non-transitory computer readable storage medium of claim 8, wherein the different spots comprise different volumes of the additional amount of the fluid.

13. An apparatus, comprising:
a dispenser that dispenses a fluid onto a surface in accordance with a dispensing protocol; and
a processor communicatively coupled to the dispenser, wherein the processor causes the dispenser to dispenses the fluid into a location of the surface in accordance with a dispense pattern that disperses the fluid over different spots in the location.

14. The apparatus of claim 13, wherein the dispense pattern comprises normalizing the fluid in a plurality of different patterns of a plurality of different layers within the location.

15. The apparatus of claim 13, further comprising:
an optical system that captures an image of the location, wherein the image of the location is analyzed by the processor to determine the dispense pattern.
